(19) United States
(12) Patent Application Publication
(10) Pub. No.: US 2007/0204039 A1
(43) Pub. Date: Aug. 30, 2007

(54) System and method of downloading restricted applications to wireless devices

(76) Inventor: Prasanna Inamdar, San Diego, CA (US)

Correspondence Address: QUALCOMM INCORPORATED, 5775 MOREHOUSE DR., SAN DIEGO, CA, 92121, US

(21) Appl. No.: 11/361,276

(22) Filed: Feb. 24, 2006

(51) Int. Cl. G06F 15/173

(52) U.S. Cl. 709/225

(57) ABSTRACT

A method of downloading an application to a wireless device is disclosed and includes requesting a download of the application. The method also includes receiving an indication that the application is restricted. Further, the method includes receiving an indication that authorization from a supervisor wireless device is required to download the application. Additionally, the method includes transmitting a request to a download server to obtain an authorization from the supervisor wireless device. The method also includes receiving an indication from the download server that the authorization from the supervisor wireless device is pending. Moreover, the method can include receiving an indication from the download server that the authorization has failed or that the authorization has succeeded. The method includes downloading the restricted application from the download server.

### BACKGROUND

I. Field

The present disclosure generally relates to wireless devices. More particularly, the disclosure relates to downloading restricted applications to wireless devices.

II. Description of Related Art

Advances in technology have resulted in smaller and more powerful wireless devices. For example, there currently exist a variety of wireless devices, including mobile phones, personal digital assistants (PDAs), laptops, and paging devices that are small, lightweight, and easily carried by users. These devices may include the ability to transmit voice and/or data over wireless networks. Further, many such wireless devices provide significant computing capabilities, and as such, are becoming tantamount to small personal computers and hand-held PDAs.

Typically, these smaller and more powerful wireless devices are often resource constrained. For example, the screen size, the amount of available memory and file system space, and the amount of input and output capabilities may be limited by the small size of the device. Because of such severe resource constraints, it is can be desirable to maintain a limited size and quantity of software applications and other information residing on such wireless devices.

Some of these wireless devices utilize application programming interfaces (APIs) that are sometimes referred to as runtime environments and software platforms. The APIs can be installed onto a wireless device to simplify the operation and programming of such wireless devices by providing generalized calls for device resources. Further, some APIs can provide software developers the ability to create software applications that are executable on such wireless devices. In addition, APIs can provide an interface between a wireless device system hardware and the software applications. As such, the wireless device functionality can be made available to the software applications by allowing the software to make a generic call for a function thus not requiring the developer to tailor its source code to the individual hardware or device on which the software is executing. Further, some APIs can provide mechanisms for secure communications between wireless devices, such as client devices and server systems, using secure cryptographic key information.

Examples of such APIs, some of which are discussed in more detail below, include those currently publicly available versions of the, Binary Runtime Environment for Wireless® (BREW®) platform, developed by Qualcomm, Inc. of San Diego, Calif. The BREW® platform can provide one or more interfaces to particular hardware and software features found on wireless devices.

Further, the BREW® platform can be used in an end-to-end software distribution system to provide a variety of benefits for wireless service operators, software developers and wireless device manufacturers and consumers. One such currently available end-to-end software distribution system, called the BREW® solution developed by QUALCOMM Incorporated, includes logic distributed over a server-client architecture, wherein the server can perform billing, security, and application distribution functionality, and wherein the client can perform application execution, security and user interface functionality.

One aspect of security includes preventing access to restricted applications, e.g., applications that require sensitive information that is generally used only for management, applications that include adult content, or applications that exceed a certain cost threshold to download. Typically, access to the restricted applications is binary in nature, i.e., a particular user is allowed access or is not allowed access. However, in certain situations, it may be desirable to selectively allow access to a requested restricted application.

Accordingly it would be advantageous to provide an improved system and method of downloading restricted applications to wireless devices.

### SUMMARY

A method of downloading an application to a wireless device is disclosed and includes requesting a download of the application. The method also includes receiving an indication that the application is restricted. Further, the method includes receiving an indication that authorization from a supervisor wireless device is required to download the application.

In a particular embodiment, the method includes transmitting a request to a download server to obtain an authorization from the supervisor wireless device. In another particular embodiment, the method includes receiving an indication from the download server that the authorization from the supervisor wireless device is pending. Further, the method can include receiving an indication from the download server that the authorization has failed or that the authorization has succeeded. Additionally, in another particular embodiment, the method includes downloading the restricted application from the download server.

In another embodiment, a method of authorizing a download of a restricted application is disclosed and includes receiving a request from a download server to authorize a download of a restricted application and displaying an indication that a subordinate wireless device is requesting the download of the restricted application.

In yet another embodiment, a method of managing application downloads is disclosed and includes receiving a download request of an application from a first device, determining whether the download of the application is restricted, and determining whether the download of the application has been previously authorized.

In still another embodiment, a communication system is disclosed and includes a first wireless device, a second wireless device, and a download server that is coupled to the first wireless device and the second wireless device. The download server includes a processor, a computer readable medium that is accessible to the processor, and a computer program that is embedded within the computer readable medium. In this embodiment, the computer program includes instructions to receive a download request of an application from a first device, instructions to determine whether the download of the application is restricted, and instructions to determine whether the download of the application has been previously authorized.

In yet still another embodiment, a wireless device is disclosed and includes a processor, a computer readable medium that is accessible to the processor, and a computer program that is embedded within the computer readable medium. In this embodiment, the computer program includes instructions to request a download of an application, instructions to receive an indication that the application is restricted, and instructions to receive an indication that authorization from a supervisor wireless device is required to download the application.

In another embodiment, a wireless device is disclosed and includes a processor, a computer readable medium that is accessible to the processor, and a computer program that is embedded within the computer readable medium. In this embodiment, the computer program includes instructions to receive a request from a download server to authorize a download of a restricted application and instructions to display an indication that a subordinate wireless device is requesting the download of the restricted application.

In yet another embodiment, a computer program is embedded within a computer readable medium. The computer program includes instructions to receive a download request of an application from a first device, instructions to determine whether the download of the application is restricted, and instructions to determine whether the download of the application has been previously authorized.

In still another embodiment, a computer program is embedded within a computer readable medium. The computer program includes instructions to request a download of an application, instructions to receive an indication that the application is restricted, and instructions to receive an indication that authorization from a supervisor wireless device is required to download the application.

In another embodiment, a computer program is embedded within a computer readable medium. The computer program includes instructions to receive a request from a download server to authorize a download of a restricted application and instructions to display an indication that a subordinate wireless device is requesting the download of the restricted application.

In yet still another embodiment, a wireless device is disclosed and includes means for requesting a download of the application, means for receiving an indication that the application is restricted, and means for receiving an indication that authorization from a supervisor wireless device is required to download the application.

In still yet another embodiment, a wireless device is disclosed and includes means for receiving a request from a download server to authorize a download of a restricted application and means for displaying an indication that a subordinate wireless device is requesting the download of the restricted application.

In another embodiment, a download server is disclosed and includes means for receiving a download request of an application from a first device, means for determining whether the download of the application is restricted, and means for determining whether the download of the application has been previously authorized.

An advantage of one or more embodiments disclosed herein can include preventing access to a restricted application.

Another advantage can include requiring authorization to download a restricted application.

Yet another advantage can include indicating to a supervisor that a subordinate is requesting a download of a restricted application.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a general diagram of a particular embodiment of a system providing communications between a wireless device and a server;

FIG. 2 is a general diagram that illustrates further details of the particular embodiment of the system of FIG. 1;

FIG. 3 is a general diagram of a system of downloading applications to wireless devices;

FIG. 4 is a flow chart illustrating a method of downloading restricted applications;

FIG. 5 is a flow chart illustrating a method of authorizing a request to download a restricted application from a download server;

FIG. 6 is a flow chart illustrating a method of controlling access to restricted applications;

FIG. 7 is a diagram of a wireless device showing a subordinate wireless device graphical user interface;

FIG. 8 is a diagram of a wireless device showing a subordinate wireless device graphical user interface;

FIG. 9 is a diagram of a wireless device showing a subordinate wireless device graphical user interface;

FIG. 10 is a diagram of a wireless device showing a subordinate wireless device graphical user interface; and

FIG. 11 is a diagram of a wireless device showing a supervisor wireless device graphical user interface

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Further, many embodiments are described in terms of sequences of actions to be performed by, for example, elements of a wireless device. It will be recognized that various actions described herein could be performed by specific circuits, e.g., application specific integrated circuits (ASICs), by program instructions being executed by one or more processors, or by a combination of both.

Further, the embodiments described herein can additionally be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform a certain action or “code operable to” perform the described action. The following detailed description describes methods, systems, software and apparatus used in connection with one or more wireless devices.

In one or more embodiments, a wireless device may utilize a runtime environment, such as a version of the Binary Runtime Environment for Wireless® (BREW®) platform developed by QUALCOMM, Inc., of San Diego, Calif. In at least one embodiment in the following description, the system used to provide communications between wireless devices and servers is implemented on a wireless device executing a runtime environment, such as the current version of the BREW® platform. However, one or more embodiments of the system used to provide communications between wireless devices and servers are suitable for use with other types of runtime environments that, for example, operate to control the execution of applications on wireless devices.

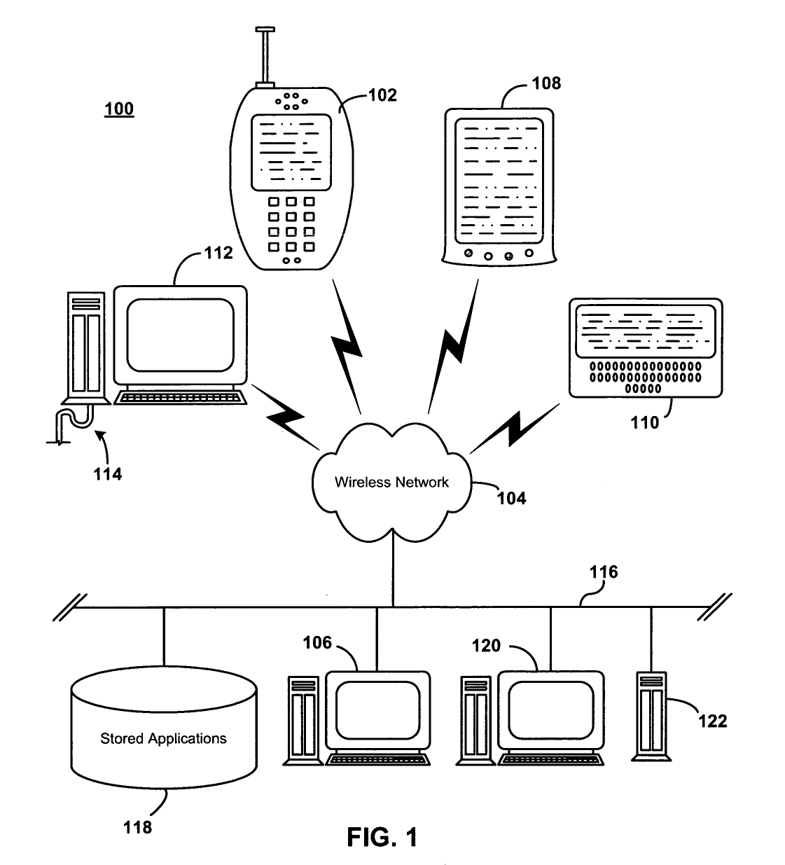

FIG. 1 illustrates a block diagram of an exemplary, non-limiting embodiment of a system 100 that may perform loading, reloading, and deletion of software application components on a wireless device, such as wireless telephone 102. The wireless telephone 102 communicates across a wireless network 104 with at least one application server 106. Further, the application server 106 can selectively transmit one or more software applications and components to one or more wireless devices across a wireless communication portal or other node having data access to the wireless network 104.

As illustrated in FIG. 1, the wireless device,can be a wireless telephone 102, a personal digital assistant 108, a pager 110, or a separate computer platform 112 that has a wireless communication portal. In a particular embodiment, the pager 110 can be a two-way text pager. Further, in an alternative embodiment, the wireless device can have a wired connection 114 to a network or the Internet. The exemplary, non-limiting system can include any form of a remote module including a wireless communication portal, including without limitation, wireless modems, PCMCIA cards, personal computers, access terminals, telephones with or without a display or keypad, or any combination or sub-combination thereof.

As depicted in FIG. 1, the application download server 106 is coupled to a network 116 with other computer elements in communication with the wireless network 104. The system 100 includes is a second server 120 and a stand-alone server 122, and each server can provide separate services and processes to the wireless devices 102, 108, 110, 112 across the wireless network 104. Further, as indicated in FIG. 1, the system 100 also includes at least one stored application database 118 that stores software applications that are downloadable by the wireless devices 102, 108, 110, 112. Different embodiments are contemplated that locate logic to perform secure communications at any one or more of the application download server 106, the second server 120 and the stand-alone server 122.

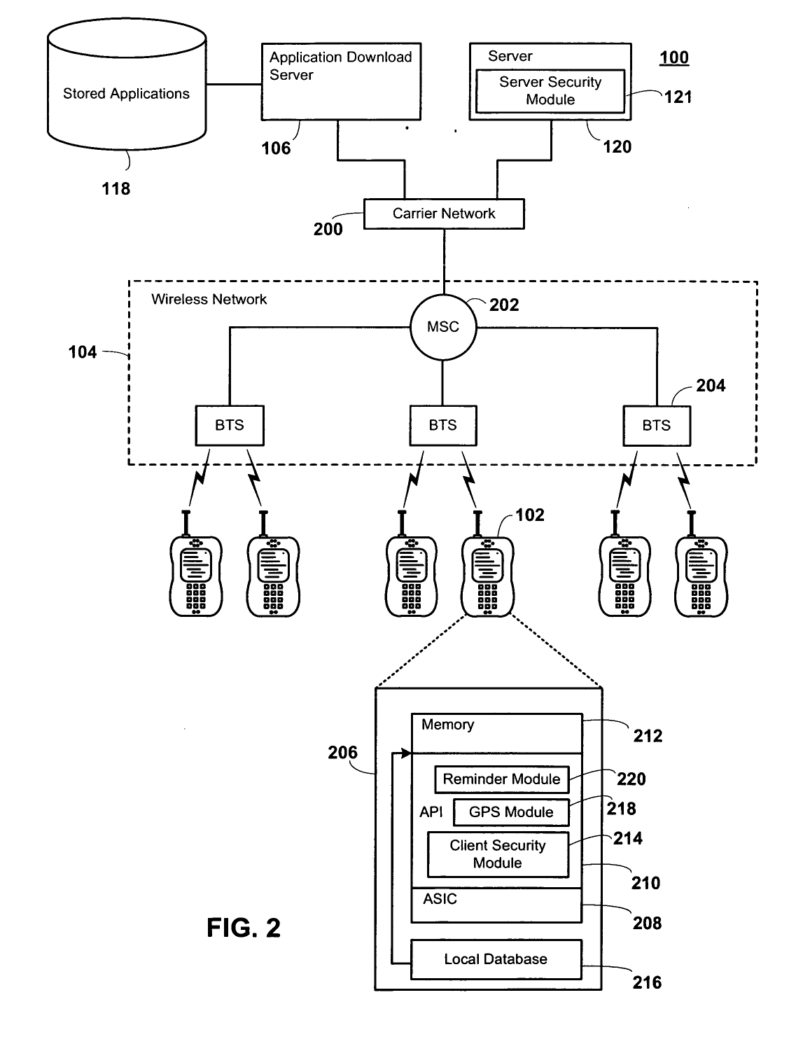

In FIG. 2, a block diagram is shown that more fully illustrates the system 100, including the components of the wireless network 104 and interrelation of the elements of the system 100. The system 100 is merely exemplary and can include any system whereby remote modules, such as the wireless devices 102, 108, 110, 112 communicate over-the-air between and among each other and/or between and among components connected via a wireless network 104, including, without limitation, wireless network carriers and/or servers. The application download server 106 and the stored application database 118, along with any other servers, such as server 120, are compatible with wireless communication services and can communicate with a carrier network 200 through a data link, such as the Internet, a secure LAN, WAN, or other network. In an illustrative embodiment, the server 120 contains a server security module 121 that further contains logic configured to provide for secure communications over the carrier network 200. In a particular embodiment, the server security module 121 can operate in conjunction with a client security module located on a wireless device, such as wireless devices 102, 108, 110, 112, to provide secure communications.

The carrier network 200 controls messages (sent as data packets) sent to a mobile switching center (37 MSC”) 202. The carrier network 200 communicates with the MSC 202 by a network, such as the Internet and/or POTS (“plain ordinary telephone system”). Typically, the network connection between the carrier network 200 and the MSC 202 transfers data, and the POTS transfers voice information. The MSC 202 is connected to multiple base transceiver stations (“BTS”) 204. The MSC 202 can be connected to the BTS 204 by both a data network and/or Internet for data transfer and POTS for voice information. The BTS 204 ultimately broadcasts messages wirelessly to the wireless devices, such as to wireless telephone 102, by the short messaging service (‘SMS”), or other over-the-air methods known in the art.

The wireless device 102 has a computer platform 206 that can receive and execute software applications transmitted from the application download server 106. The computer platform 206 may be implemented as an application-specific integrated circuit (“ASIC” 208), a processor, microprocessor, logic circuit, or other data processing device. The ASIC 208 is installed at the time of manufacture of the wireless device. The ASIC 208 or other processor can execute an application programming interface (“API”) 210 layer that interfaces with resident programs in the memory 212 of the wireless device. The memory 212 can be comprised of read-only or random-access memory (ROM or RAM), EEPROM, flash memory, or any other memory suitable for computer platforms.

The API 210 also includes a client security module 214 containing logic configured to provide for secure communications over the carrier network 200. In a particular embodiment, the client security module 214 can operate in conjunction with the server security module 121 to provide secure communications. As illustrated in FIG. 2, the computer platform 206 can further include a local database 216 that can hold applications not actively used in memory 212. In an illustrative embodiment, the local database 216 is stored within a flash memory cell, but it can be stored within any secondary storage device as known in the art, such as magnetic media, EEPROM, optical media, tape, or floppy or hard disk.

A wireless device, e.g., the wireless device 102, can download one or more software applications, such as games, news, stock monitors, and the like, from the application download server 106. Further, the wireless device 102 can store the downloaded applications in the local database 216, when not in use, and can load stored resident applications from the local database 216 to memory 212 for execution by the API 210 when desired by the user. Further, communications over the wireless network 104 may be performed in a secure manner, at least in part, due to the interaction and operation of the client security module 214 and the server security module 121. As shown in FIG. 2, the API 210 can also include a global positioning system (GPS) module 218 and a reminder module 220.

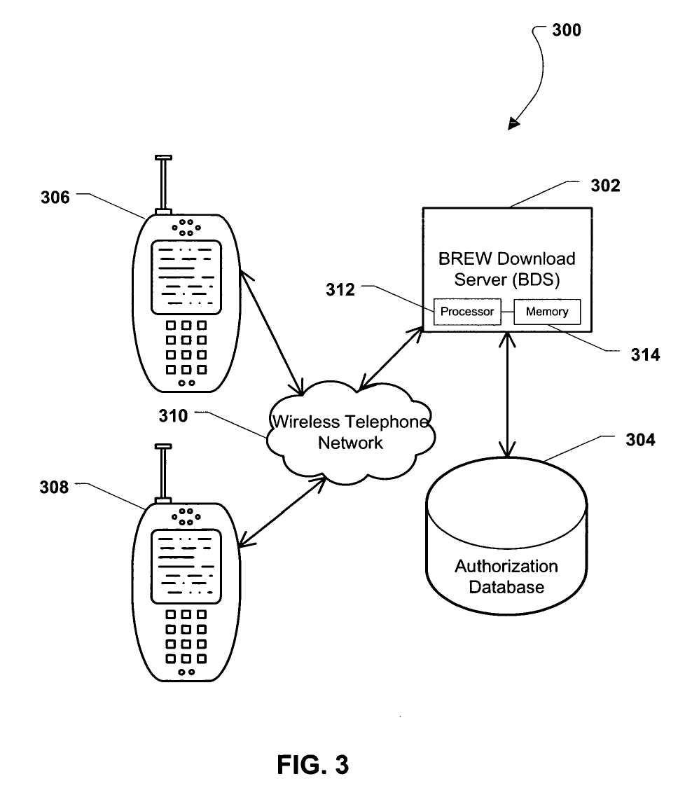

FIG. 3 depicts a system, designated 300, that can be used to download one or more applications to a wireless device. As illustrated, the system 300 includes a download server 302, e.g., a BREW download server. An authorization database 304 can be coupled to the download server 302. In a particular embodiment, the authorization database 304 includes information concerning various restricted applications. For example, the authorization database 304 can indicate whether particular restricted applications are authorized for download to particular wireless devices. Additionally, the authorization database 304 can include supervisory information, e.g., who to contact in order to obtain an authorization to download and/or use a particular application.

Additionally, as shown in FIG. 3, a first wireless device 306 and a second wireless device 308 can communicate with the download server via a wireless telephone network 310. In a particular embodiment, the first wireless device 306 is a subordinate wireless device and the second wireless device is a supervisor wireless device. For example, the subordinate wireless device can belong to an employee and the supervisor wireless device can belong to an employer. Further, the subordinate wireless device can belong to a child and the supervisor wireless device can belong to a parent.

In a particular embodiment, the first wireless device 306 and the second wireless device 308 can be a wireless telephone, a cellular telephone, a lap top computer, a desktop computer, a handheld computer, a portable digital assistant (PDA), or any other electronic device that is configured to communicate via wireless connection or a wired connection.

As illustrated in FIG. 3, the download server 302 can include a processor 312 and a computer readable medium 314, e.g., a memory, that is accessible to the processor 312. In a particular embodiment, the download server 302 can provide a mobile shop, i.e., a purchasing interface or shopping application, that one or more wireless devices can communicate with in order to purchase and download one or more applications stored at the download server 302, or at a database coupled to the download server 302. In a particular embodiment, one or more of the applications available via the download server can be restricted applications, e.g., applications that are restricted for download and/or restricted for use. Examples of restricted applications can include applications that require sensitive information that is generally used only for management, e.g., applications that list the salaries for the employees of a company. Restricted applications can also include applications that include adult content and applications that exceed a certain cost threshold to download

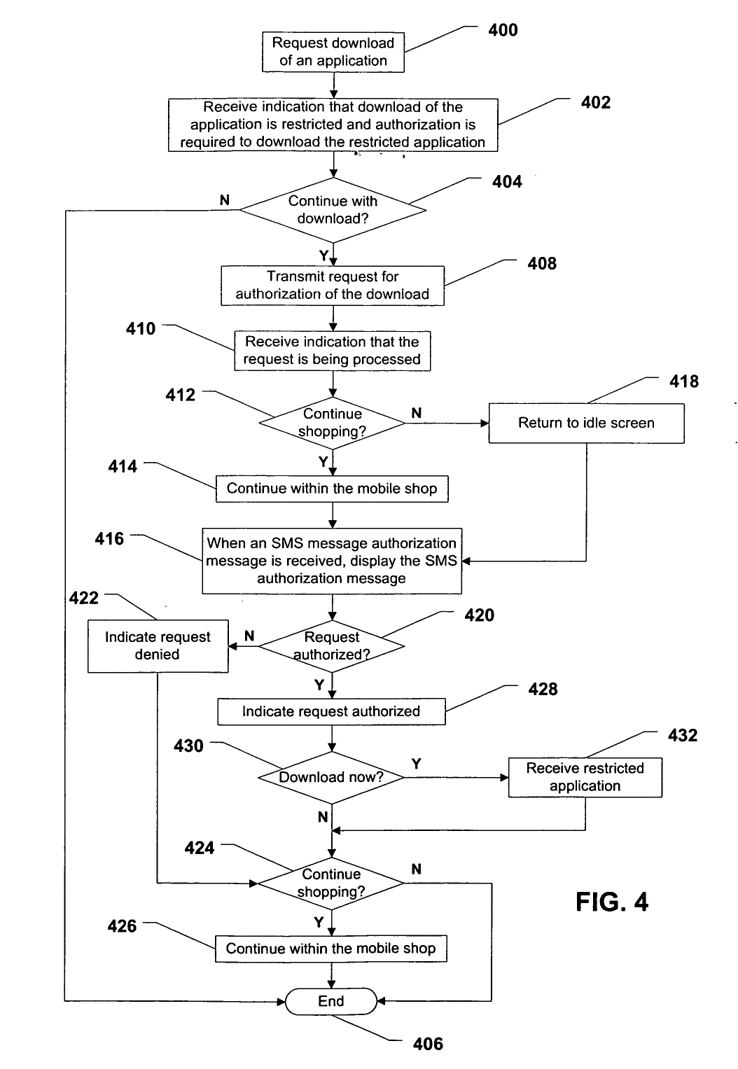

In a particular embodiment, a computer program can be embedded within the computer readable medium 314 and can be used to control the downloads of applications to the wireless devices 306, 308. More particularly, when a subordinate wireless device 306 requests the download of a restricted application, the download server 302 can locate a supervisor wireless device 308 that is associated with the subordinate wireless device 306. Also, the download server 302 can request that the subordinate wireless device 306, or a user thereof, authorize the download of the restricted application. FIGS. 4 through 6, described in detail below, illustrate exemplary, non-limiting methods that can be used to control the download of restricted applications to subordinate wireless devices.

Referring to FIG. 4, a method of downloading applications to a wireless device is shown and commences at block 400. In a particular embodiment, the method is described with respect to a single subordinate wireless device seeking permission to download a restricted application from a single supervisor wireless device. In an alternative embodiment, multiple subordinate wireless devices can seek permission to download a restricted application from one or more supervisor wireless devices. Additionally, in a particular embodiment, the method involves seeking permission to download restricted applications. In an alternative embodiment, a subordinate wireless device may be permitted to download all applications, but execution of the application may be restricted. As such, a subordinate wireless device may contact a supervisor wireless device in order to obtain authorization to unlock the application to be executed at the subordinate wireless device.

At block 400, a subordinate wireless device requests a download of an application, e.g., from a mobile shop provided by a download server. In a particular embodiment, the request can be sent to the download server using short message service (SMS), i.e., text messaging. Alternatively, the request can be sent using another format, e.g., hypertext transfer protocol (HTTP). Moving to block 402, the subordinate wireless device receives an indication that the download of the application is restricted and that permission is required from a supervisor in order to download the restricted application to the subordinate wireless device.

At decision step 404, the subordinate wireless device queries the user of the subordinate wireless device as to whether he or she would like to continue with the download of the restricted application. If not, the method ends at state 406. Otherwise, the method continues to block 408 and the subordinate wireless device transmits a request to authorize the download of the restricted application to the subordinate wireless device. At block 410, the subordinate wireless device receives an indication that the authorization of the restricted download is pending.

Proceeding to decision step 412, the subordinate wireless device queries the user in order to decide whether the user wishes to continue shopping while the request to authorize the restricted download is being processed. If so, the method moves to block 414 and the subordinate wireless device allows the user to continue shopping within the mobile application download shop. The method then moves to block 416. Returning to decision step 412, if the user does not want to continue shopping the method proceeds to block 418 and the subordinate wireless device presents an idle screen to the user. From block 418, the method continues to block 416.

At block 416, when an SMS message authorization message is received, the subordinate wireless device displays the SMS authorization message for the user. Thereafter, at block 420, the subordinate wireless device determines whether the request to download the restricted application is authorized. If the request is not authorized, the method moves to block 422 and the subordinate wireless device indicates to the user that the request is denied. Then, the method proceeds to decision step 424 and the subordinate wireless device queries the user to determine if the user would like to continue shopping. If not, the method ends at state 406. Otherwise, the method moves to block 426 and the subordinate wireless device allows the user to continue shopping within the mobile application download shop. The method then ends at state 406.

Returning to decision step 420, when the request to authorize the download of the restricted application is approved, the method moves to block 428. At block 428, the subordinate wireless device indicates to the user that the request to authorize the download of the restricted application is approved. Proceeding to decision step 430, the subordinate wireless device queries the user to determine if the user wants to download the restricted application at the present time. If not, the method moves to decision step 424 and the user is queried to determine if he or she would like to continue shopping. The method then continues as described herein. Returning to decision step 430, if the user wants to download the restricted application at the present time, the method proceeds to block 432 and the subordinate wireless device receives the restricted application. The method then moves to decision step 424 and continues as described herein.

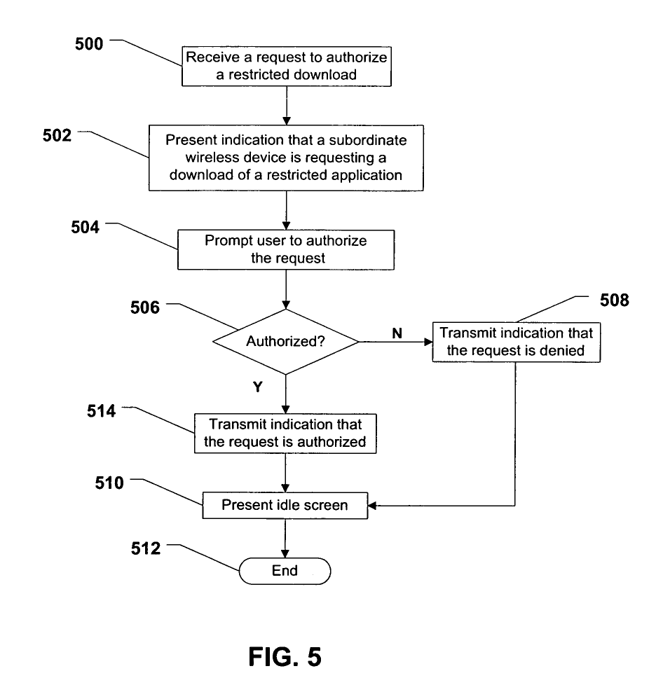

FIG. 5 illustrates a method of authorizing a request to download a restricted application from a download server. Beginning at block 500, a supervisor wireless device receives an SMS authorization request from a download server. At block 502, the supervisor wireless device presents an indication to the user of the supervisor wireless device that a subordinate wireless device is requesting a download of a restricted application. Next, at block 504, the supervisor wireless device prompts the user of the supervisor wireless device to authorize the request to download the restricted application to the subordinate wireless device.

Moving to decision step 506, the supervisor wireless device determines whether the request to download the restricted application is authorized. If the request is not authorized, the method proceeds to block 508 and the supervisor device transmits an indication to the download server that the request is denied. Then, the method continues to block 510 and the supervisor wireless device presents an idle screen to the user. The method then ends at state 512.

Returning to decision step 506, if the request to download the restricted application is authorized, the method continues to block 514. At block 514, the subordinate wireless device transmits an indication that the request to download the restricted application is authorized. Next, at block 510, the supervisor wireless device presents an idle screen to the user. The method then ends at state 512.

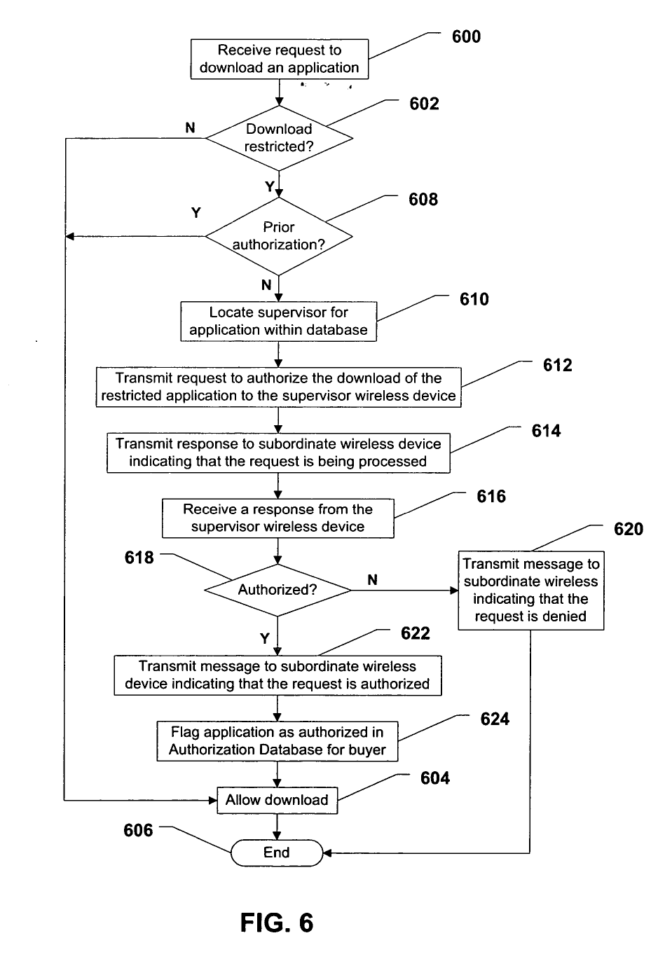

Referring to FIG. 6, a method of controlling access to restricted applications is shown and commences at block 600. At block 600, a download server receives a request to download an application from a subordinate wireless device. Next, at decision step 602, the download server determines whether the download of the application is restricted, i.e., whether authorization is required prior to allowing the download of the restricted application to the subordinate wireless device. If the application is not restricted for download, the method proceeds to block 604 and the download server allows the download to the requesting subordinate wireless device. The method then ends at state 606.

Returning to decision step 602, if the download of the application is restricted, the method moves to decision step 608 and the download server determines whether prior authorization has been given for the download of the restricted application to the requesting subordinate wireless device. In a particular embodiment, the download server can search the authorization database in order to determine if prior authorization has been received to authorize download of the restricted application. The authorization database can indicate whether authorization has been received for multiple downloads of the restricted application to the same subordinate wireless device or to multiple subordinate wireless devices. If prior authorization to download the restricted application to the requesting subordinate wireless device has been received, the method proceeds to block 604 and the download is allowed. The method then ends at state 606.

Returning to decision step 608, if prior authorization has not been given for the download of the restricted application to the requesting subordinate wireless device, the method continues to block 610. At block 610, the download server locates the supervisor of the requesting device within a database coupled to the download server, e.g., an authorization database. Then, at block 612, the download server transmits a message to the supervisor, e.g., to a supervisor wireless device associated with the supervisor, requesting authorization of the download of the restricted application to the subordinate wireless device. Moving to block 614, the download server transmits a response to the subordinate wireless device that indicates that the request for authorization to download the restricted application is being processed. In a particular embodiment, the communication with the wireless devices can be made via SMS messages.

At block 616, the download server receives a response from the supervisor wireless device. Next, at decision step 618, the download server determines whether the request to download the restricted application has been authorized. If the request is not authorized, the method moves to block 620 and the download server transmits a message to the subordinate wireless device that the request for authorization to download the restricted application is denied. The method then ends at state 606.

Returning to decision step 618, when the download server determines that the request to download the restricted application has been authorized by the user of the supervisor wireless device, the method proceeds to block 622. At block 622, the download server transmits a message to the subordinate wireless device indicating that the request to download the restricted application is authorized. Thereafter, at block 624, the download server flags the restricted application within the authorization database as being authorized for download by the requesting subordinate wireless device. Moving to block 604, the download server allows the download of the restricted device to the subordinate wireless device. Then, the method ends at state 606.

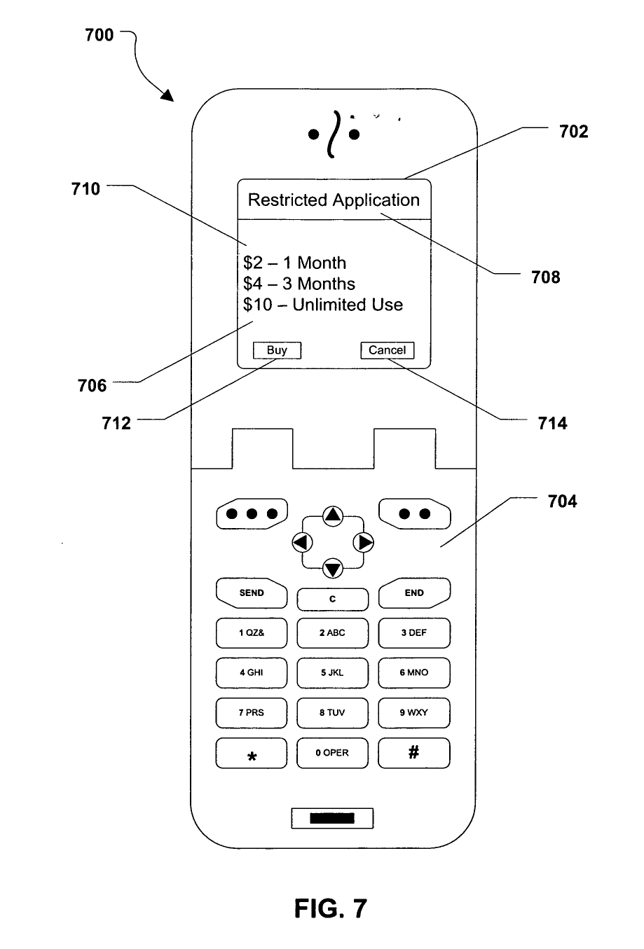

Referring to FIG. 7, a wireless device is shown and is generally designated 800. As shown, the wireless device includes a display 702 and a keypad 704. FIG. 7 further illustrates a first graphical user interface (GUI) 706 that can be presented to a user via the display 702 of the wireless device 700. As shown, the GUI 706 can include a screen header 708 and a first text message 710. In a particular embodiment, the first GUI 706 can be presented to the user of a subordinate wireless device. As indicated in FIG. 7, the GUI 706 can include a buy soft button 712 and a cancel soft button 714. While a user is shopping via a download server, the screen header 708 can present an indication that the user is attempting to download a restricted application. The first text message 710 can present options to the user. For example, the first text message 710 can indicate that the user can purchase the restricted application for $2 for one month, for $4 for 3 months, or $10 for unlimited use. In a particular embodiment, the user can choose to buy the application by selecting the buy soft button 712 or the user can cancel the transaction by selecting the cancel soft button 714.

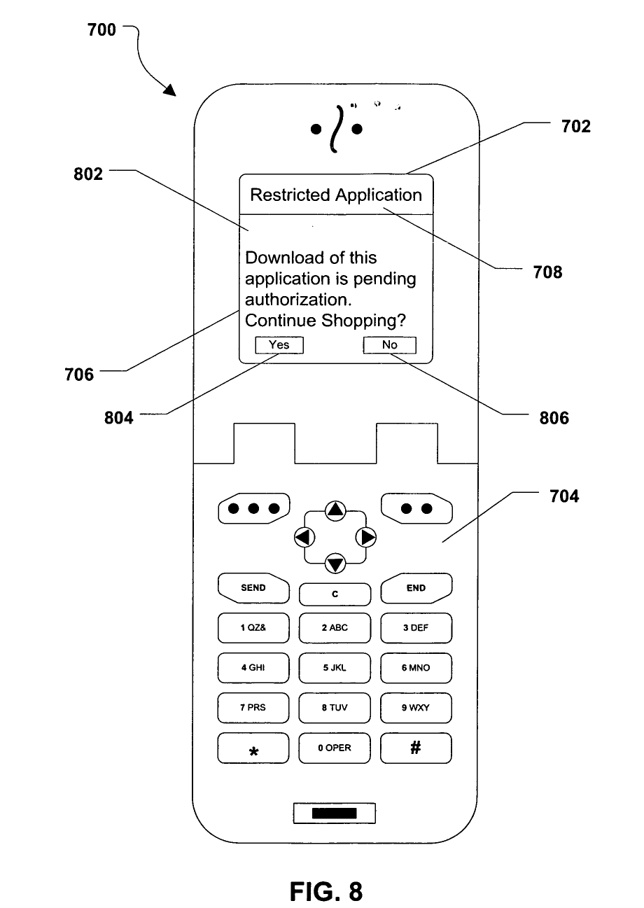

FIG. 8 indicates that the first GUI 706 can include a second text message 802 that can be presented to the user after he or she chooses to purchase the restricted application. Further, FIG. 8 indicates that the first GUI 706 can include a yes soft button 804 and a no soft button 806. In an illustrative embodiment, the second text message 802 can indicate that the “Download of this application is pending authorization.” Further, the second text message 802 can query the user to “Continue Shopping?” In a particular embodiment, the user can select the yes soft button 804 to continue shopping or the user can select the no soft button 806 in order to exit the mobile shop presented via the download server.

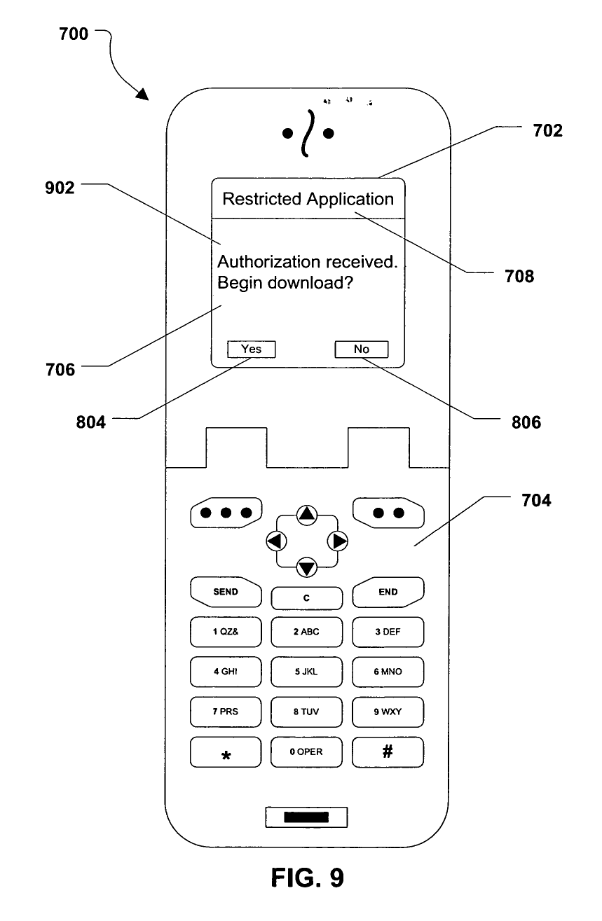

Referring to FIG. 9, the first GUI 706 can include a third text message 902. As illustrated in FIG. 9, the third text message 902 can indicate, “Authorization received. Begin download?” A user can choose to download the restricted application by toggling the yes soft button 804. Otherwise, the user can choose not to download the restricted application by toggling the no soft button 806.

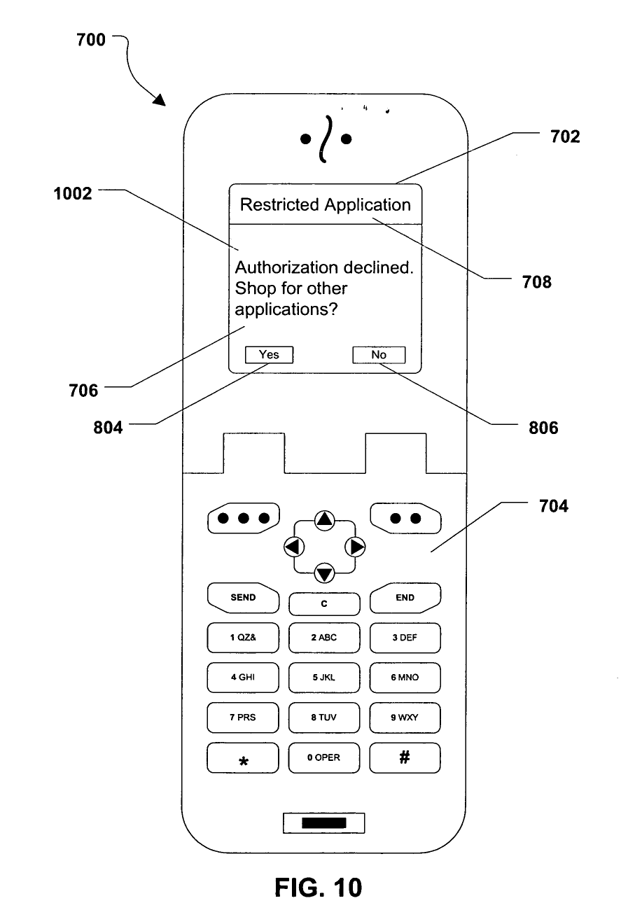

As shown in FIG. 10, the first GUI 706 can also include a fourth text message 1002 that can be presented to the user via the display 702 of the wireless device 700. In an illustrative embodiment, the fourth text message 1002 can state, “Authorization declined. Shop for other applications?” A user can respond to the query by toggling the yes soft button 804 or the no soft button 806.

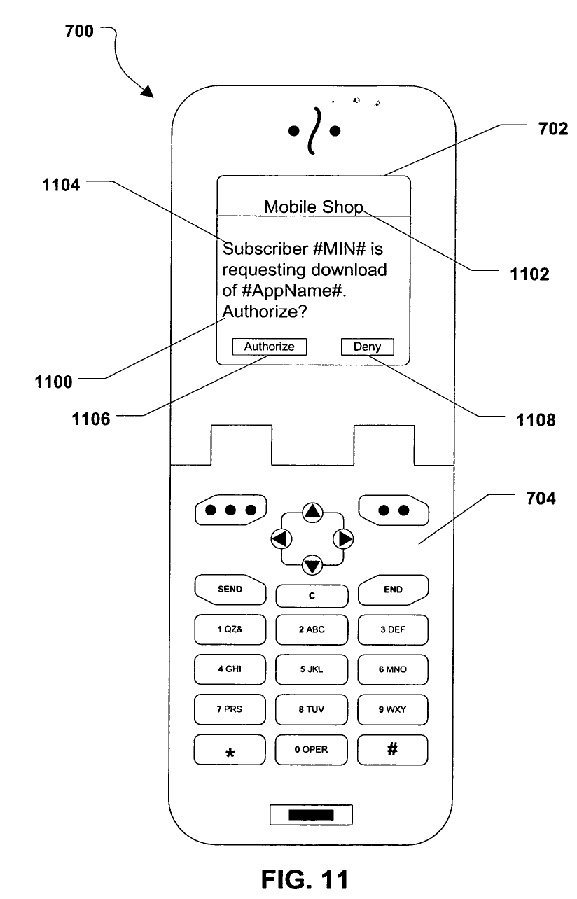

Referring to FIG. 11, a second GUI is illustrated and is generally designated 1100. In a particular embodiment, the second GUI 1100 can be presented to the user of a supervisor wireless device. As shown in FIG. 11, the second GUI 1100 can include a screen header 1102 and a text message 1104. Further, the second GUI 1100 can include an authorize soft button 1106 and a deny soft button 1108.

In a particular embodiment, the screen header 1102 can indicate that the supervisor wireless device is in contact with a mobile shop. Further, the text message can indicate that, “Subscriber <Mobile Id Number> is requesting download of <Application Name>. Authorize?” In another embodiment, the requesting users name can be presented to the user of the supervisor wireless device instead of the mobile identification number. The user can authorize or deny the request by toggling the authorize soft button 1106 or the deny soft button 1108.

With the configuration of structure disclosed herein, the system and method can allow a supervisor to prevent a subordinate from downloading one or more restricted applications. Further, when a subordinate requests a download of a restricted application, the supervisor can be prompted to authorize the download. When authorized, the subordinate can download the restricted application to his or her wireless device.

Alternatively, the system and method can allow a supervisor to unlock a restricted application that has been downloaded to a subordinate wireless device. As such, the supervisor can be prompted in order to authorize use of the restricted application. When authorization is received, the download server can transmit a key to the subordinate wireless device that can allow the subordinate wireless device to unlock and execute the restricted application.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in RAM memory, flash memory, ROM memory, PROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a wireless device or a user terminal. In the alternative, the processor and the storage medium may reside as discrete components in a wireless device or user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features as defined by the following claims.

What is claimed is:

1. A method of downloading an application to a wireless device, the method comprising:
requesting a download of the application;
receiving an indication that the application is restricted; and
receiving an indication that authorization from a supervisor wireless device is required to download the application.

2. The method of claim 1, further comprising transmitting a request to a download server to obtain an authorization from the supervisor wireless device.

3. The method of claim 2, further comprising receiving an indication from the download server that the authorization from the supervisor wireless device is pending.

4. The method of claim 3, further comprising receiving an indication from the download server that the authorization failed.

5. The method of claim 3, further comprising receiving an indication from the download server that the authorization succeeded.

6. The method of claim 5, further comprising downloading the restricted application from the download server.

7. A method of authorizing a download of a restricted application, the method comprising:
receiving a request from a download server to authorize a download of a restricted application; and
displaying an indication that a subordinate wireless device is requesting the download of the restricted application.

8. The method of claim 7, further comprising prompting a user to authorize the request.

9. The method of claim 8, further comprising sending an indication that the request is denied.

10. The method of claim 8, further comprising sending an indication that the request is authorized.

11. A method of managing application downloads, the method comprising:
receiving a download request of an application from a first device;
determining whether the download of the application is restricted; and
determining whether the download of the application has been previously authorized.

12. The method of claim 11, further comprising allowing the download when the download of the restricted application has been previously authorized.

13. The method of claim 11, further comprising locating a second wireless device to authorize the download to the first wireless device within a database.

14. The method of claim 13, further comprising sending a message to the second wireless device requesting authorization of the download of the restricted application.

15. The method of claim 14, further comprising sending a response to the first wireless device indicating that authorization is pending.

16. The method of claim 15, further comprising receiving an authorization response from the second wireless device.

17. The method of claim 16, further comprising determining whether the user of the second wireless device has authorized download of the restricted application.

18. The method of claim 17, further comprising sending a message to the first wireless device that the request is denied.

19. The method of claim 17, further comprising sending a message to the first wireless device that the request is authorized.

20. The method of claim 19, further comprising flagging the restricted application as authorized for download to the first wireless device in an authorization database.

21. The method of claim 20, further comprising allowing download of the restricted application to the first wireless device.

22. A communication system, comprising:
a first wireless device;
a second wireless device; and
a download server coupled to the first wireless device and the second wireless device, the download server comprising:
a processor;
a computer readable medium accessible to the processor; and
a computer program embedded within the computer readable medium, the computer program comprising:
instructions to receive a download request of an application from a first device;
instructions to determine whether the download of the application is restricted; and
instructions to determine whether the download of the application has been previously authorized.

23. A wireless device, comprising:
a processor;
a computer readable medium accessible to the processor; and
a computer program embedded within the computer readable medium, the computer program comprising:
instructions to request a download of an application;
instructions to receive an indication that the application is restricted; and
instructions to receive an indication that authorization from a supervisor wireless device is required to download the application.

24. A wireless device, comprising:
a processor;
a computer readable medium accessible to the processor; and
a computer program embedded within the computer readable medium, the computer program comprising:
instructions to receive a request from a download server to authorize a download of a restricted application; and
instructions to display an indication that a subordinate wireless device is requesting the download of the restricted application.

25. A computer program embedded within a computer readable medium, the computer program comprising:
instructions to receive a download request of an application from a first device;
instructions to determine whether the download of the application is restricted; and
instructions to determine whether the download of the application has been previously authorized.

26. A computer program embedded within a computer readable medium, the computer program comprising:
instructions to request a download of an application;
instructions to receive an indication that the application is restricted; and
instructions to receive an indication that authorization from a supervisor wireless device is required to download the application.

27. A computer program embedded within a computer readable medium, the computer program comprising:
instructions to receive a request from a download server to authorize a download of a restricted application; and
instructions to display an indication that a subordinate wireless device is requesting the download of the restricted application.

28. A wireless device, comprising:
means for requesting a download of the application;
means for receiving an indication that the application is restricted; and
means for receiving an indication that authorization from a supervisor wireless device is required to download the application.

29. A wireless device, comprising:
means for receiving a request from a download server to authorize a download of a restricted application; and
means for displaying an indication that a subordinate wireless device is requesting the download of the restricted application.

30. A download server, comprising:
means for receiving a download request of an application from a first device;
means for determining whether the download of the application is restricted; and
means for determining whether the download of the application has been previously authorized.
